(19) United States
(12) Patent Application Publication
(10) Pub. No.: US 2006/0259504 A1
(43) Pub. Date: Nov. 16, 2006

(54) Portable electronic device and list display method

(75) Inventor: Masayuki Kusu, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/241,308

(22) Filed: Sep. 30, 2005

(30) Foreign Application Priority Data
May 11, 2005 (JP) 2005-138668

(51) Int. Cl. G06F 7/00

(52) U.S. Cl. 707/102

(57) ABSTRACT

A portable electronic device includes a database configured to store therein a plurality of lists each including at least one list element, a display configured to display the list elements, and controller configured to read list elements to be displayed from the database and to display the list elements on the display. The controller reads the list elements into a work memory for display from the database based on a identification data as to whether to read all the list elements into a work memory for display.

### CROSS-REFERENCE TO RELATED APPLICATIONS

This application is based upon and claims the benefit of priority from prior Japanese Patent Application No. 2005-138668, filed May 11, 2005, the entire contents of which are incorporated herein by reference.

### BACKGROUND OF THE INVENTION

1. Field of the Invention

The present invention relates to a portable electronic device and a list display method.

2. Description of the Related Art

In many portable electronic devices such as portable phone, since a display area is limited, various types of information are displayed on a screen in a liquid crystal display device (LCD) in the form of list (hereinafter, simply referred to as “list”). Here, two methods are known in order to display list information for displaying a list on the screen.

A first method is to read information for displaying all lists registered in a database or the like (hereinafter, referred to as “display information”) on a work memory for display and to display only necessary part for display on the screen. Specifically, as shown in FIG. 1A and FIG. 1B, if it is assumed that five lists are displayed on the screen when there are 10 list elements (each list in the lists is referred to as “list element” in order to distinguish from the lists), all of the ten lists are first read. Then desired lists (list 3 to list 7 in FIG. 1B) therefrom are displayed (FIG. 1A). When one desires to display other lists, a next item of the lists is displayed by, for example, scrolling down (FIG. 1B). In this manner, all the display information is read on the work memory in the first method so that the lists can be fast displayed. However, on the contrary,

(1) when a large amount of display information is present, the amount of consumption of memory accordingly increases. Further, there is a problem that decrease in a response speed is caused along with the increase in the amount of consumption of memory.

(2) When the number of list elements dynamically changes, or in the case of address book or received e-mail box, since the necessary amount of consumption of memory cannot be calculated previously, it is necessary to calculate the necessary amount of consumption of memory according to the number of items.

Thus, there is proposed a second method in which only part to be displayed on the screen is read on the work memory and is displayed (see FIG. 2A, FIG. 2B and Jpn. Pat. Appln. KOKOKU Publication No. 6-77231, for example). In this method, as shown in FIG. 2A similarly as in the first method, if one wants to display list 4 to list 8 by scrolling down the screen when list 3 to list 7 are displayed, a storage area for list 3 is released on the work memory to save a storage area for list 8 as shown in FIG. 2B. According to this method, since the display range is determined in designing the screen, the memory capacity for displaying list elements can be calculated (that is, only the memory capacity for displaying five lists has to be saved in FIG. 2A and FIG. 2B). Further, since the portable electronic device is limited in the capacity for the work memory or database and its addition is impossible in many apparatuses, it is preferable to reduce the amount of consumption of memory.

As described above, although the list elements not displayed on the screen are displayed by user's scrolling the screen in the second method similarly as in the first method, the area used by the item of the list element which cannot be seen by scrolling is released and an area to be used by the list element to be newly displayed is saved instead. Specifically, the amount of consumption of memory along with user's scrolling of the screen does not change, and the amount of consumption of memory does not increase even when the number of list elements is several hundreds (or many). As described above, since the number of list elements to be displayed does not increase in the second method even if the number of list elements registered in the database or the like increases, the amount of consumption of memory to be used for the display processing or the processing time does not change as in the case where the number of items is small. Thus, when the number of list elements registered in the database or the like is small, a processing of changing list items along with the screen scrolling in the second method is later than a processing of scrolling the screen without changing the list items in the first method.

Since the second method is different from a list method previously mounted, there is a problem that the program requires to be corrected, which requires more cost or time.

### BRIEF SUMMARY OF THE INVENTION

The present invention provides a portable electronic device and a list display method having the advantages of the above first and second methods.

A portable electronic device according to one aspect of the present invention is characterized by comprising a database configured to store therein a plurality of lists each including at least one list element; a display configured to display the list elements; and a controller configured to read the list elements to be displayed from the database and to display the list elements on the display, wherein the controller reads the list elements into a work memory for display from the database based on a identification data as to whether to read all the list elements into a work memory for display.

### BRIEF DESCRIPTION OF THE SEVERAL VIEWS OF THE DRAWING

FIGS. 1A and 1B are diagrams for explaining a conventional first display method;

FIGS. 2A and 2B are diagrams for explaining a conventional second display method;

FIG. 3 is a perspective view of an appearance of a portable electronic device to which a list display method according to an embodiment of the present invention is applied;

FIG. 4 is a block diagram of essential parts for displaying;

FIG. 5 is a flowchart showing an operation in creating a list; and

FIG. 6 is a flowchart of a display method based on the created list form.

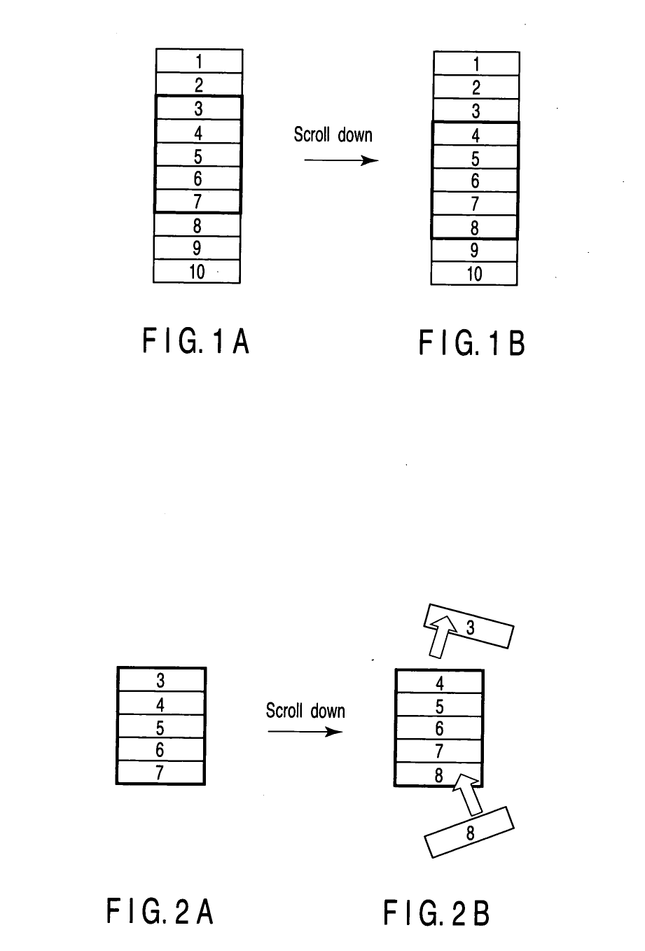

### DETAILED DESCRIPTION OF THE INVENTION

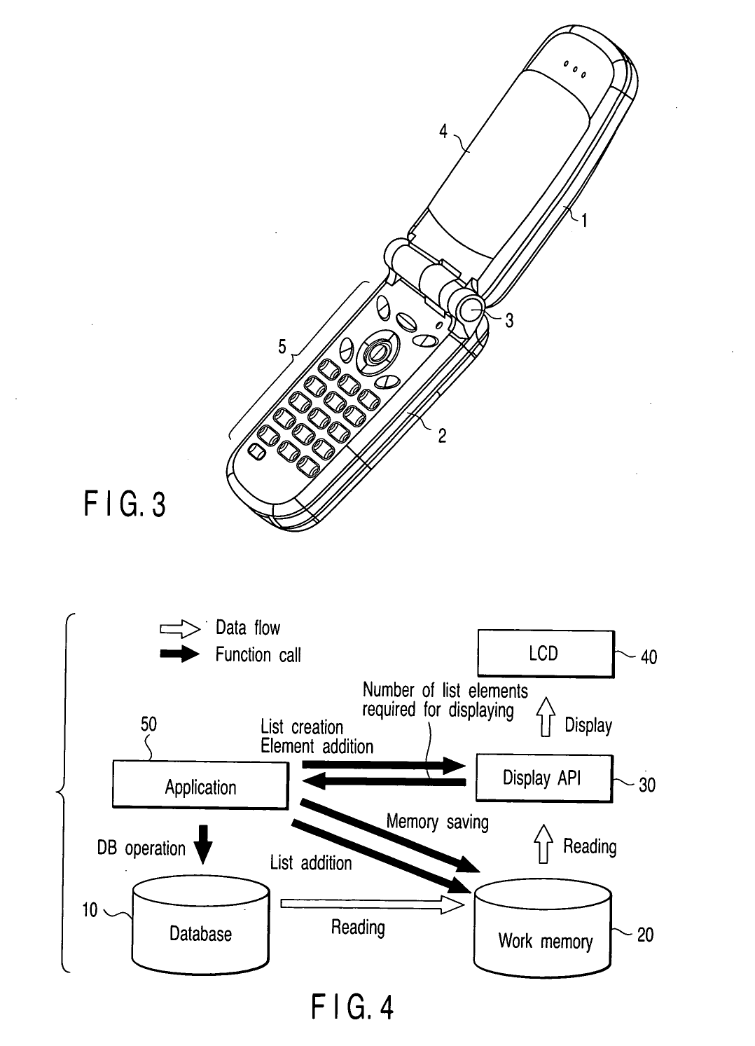

An embodiment according to the present invention will be described below with reference to the drawings. FIG. 3 is a perspective view of an appearance of a portable electronic device to which a list display method according to the embodiment of the present invention is applied. This portable electronic device is a so-called foldable portable communication terminal in which an upper portion 1 and a lower portion 2 are rotatably connected through a hinge mechanism 3, and FIG. 3 shows a state where each portion 1, 2 is opened.

The upper portion 1 is arranged with a main LCD (Liquid Crystal Display) 4 at its front and a sub-LCD (Liquid Crystal Display) at its back. On the other hand, the lower portion 2 incorporates therein a main printed wiring board (not shown), a key input device 5 and the like.

FIG. 4 is a block diagram of essential parts for displaying in the portable electronic device as constructed above. FIG. 4 shows a database 10 made of a nonvolatile memory (for example, EEPROM) or the like, a work memory 20 made of fast-accessible memory (for example, DRAM) or the like, a display API 30 for displaying a list read by the work memory 20 on a LCD 40, and the LCD 40 for performing list displaying. The database 10, the work memory 20 and the display API 30 are controlled by an application 50 operating on a CPU (not shown), respectively. Although the actual control is performed by a computing device such as the CPU through an application, the following description is made assuming that the display control is performed by the application 50.

In FIG. 4, the database 10 stores therein various types of list data used by the application 50. When the application 50 accesses the database 10, the application 50 saves an area for list data storage in the work memory 20, and then reads predetermined list data from the database 10 to write it on the work memory 20. Next, the display API 30 reads the list data from the work memory 20, and the application 50 adds a list element to the display API 30 as needed. Then, the display API 30 sends the list to the LCD 40, and the LCD 40 displays the received list thereon.

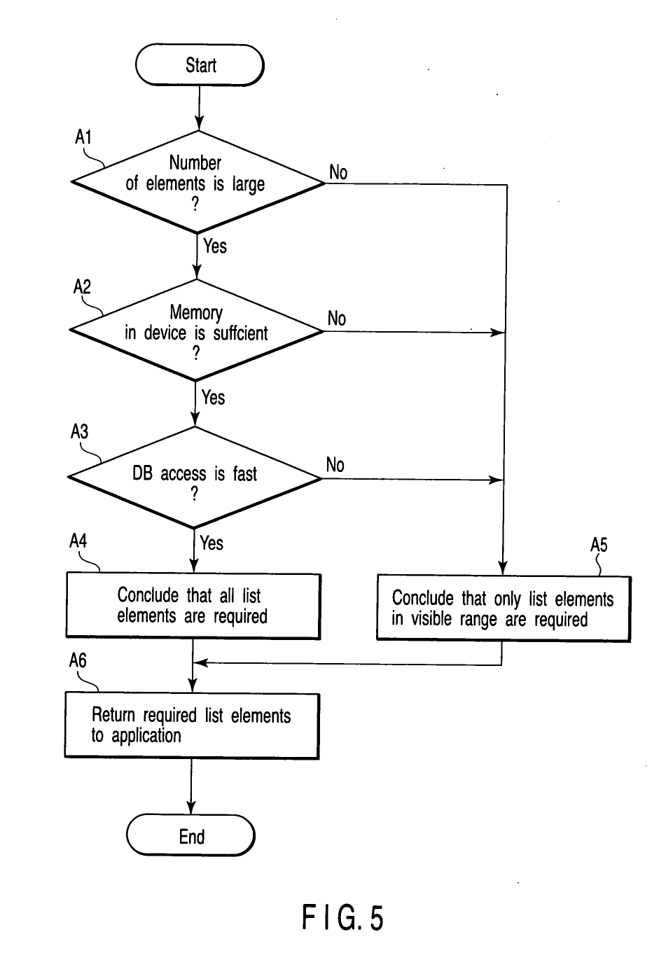

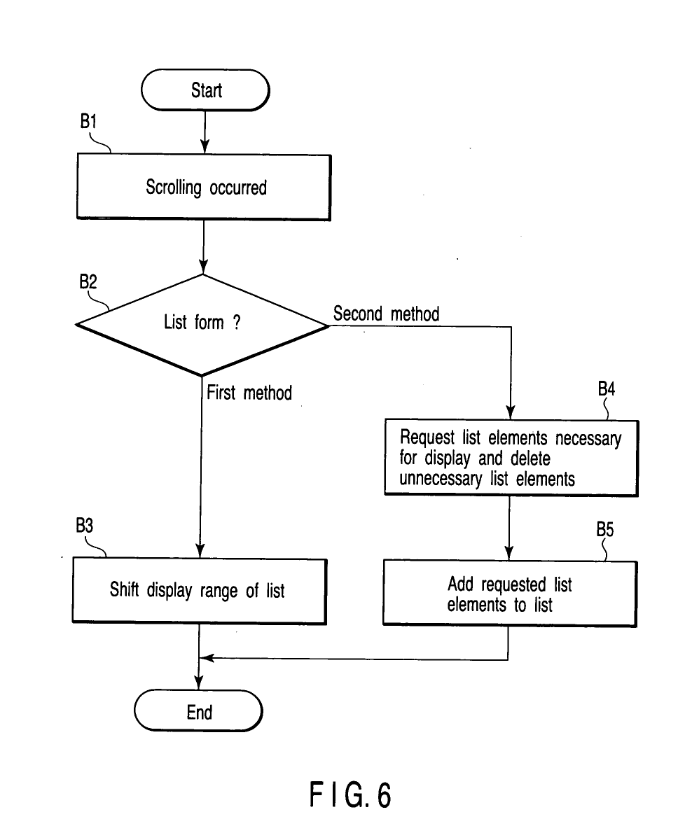

An operation according to the present invention with respect to the portable electronic device according to the embodiment of the present invention as constructed above will be described with reference to FIGS. 5 and 6. FIG. 5 is a flowchart showing an operation in creating a list, and FIG. 6 is a flowchart of a display method based on the created list form.

At first, the operation in creating a list will be described with reference to FIG. 5.

The display API 30 makes three determinations in creating a list. Based on the determination, it determines whether to take a list according to the first method (hereinafter, referred to as “first list”) or to take a list according to the second method (hereinafter, referred to as “second list”), and returns the number of list elements to be written into the work memory by the application 50 to the application 50. Specifically, it is first checked whether the number of lists is small (step A1), it is next checked whether the work memory 20 is sufficient (step A2), and it is finally checked whether access to the database 10 (that is, time after accessing the database 10 until reading data and displaying it on the LCD 40) is fast (step A3).

As a result of checking in steps A1 to A3, when the number of list elements is small (Yes in step A1), the work memory 20 is sufficient (Yes in step A2), and access to the database 10 is fast (Yes in step A3), it is determined to create the first list, that is, a list for reading all the lists on the work memory 20 (step A4). As a result of checking from steps A1 to A3, if any one check is “No”, it is determined to create the second list, that is, a list for reading only lists for displaying (step A5). Discrimination between the first list and the second list may be performed by setting a flag on the header. For example, the first and second lists may be discriminated by adding a dedicated field (1-bit data will suffice) to the header of the list and based on a value of data of the field (for example, 1 or 0). Furthermore, the number of all list elements (total number) is set in the dedicated field in the header of the list when the application 50 creates a list, and the display API 30 may discriminate the first list from the second list based on a value of the data of the field (for example, less than 20, 20 or more).

The number of list elements determined in step A4 or step A5 is returned to the application 50 (step A6), the application 50 reads the list from the database 10 according to the value returned by the display API 30 and writes it into the work memory 20.

In the above processing, the number of lists depends on the size of the LCD to be displayed. For example, when the portable electronic device is a portable phone, the first list is preferable if the number of lists is 20 or less. This is because the use amount of memory is reduced when all the lists are assumed as the second list, but the display speed is rather reduced when the number of lists is small. Furthermore, since the capacity of the mounted work memory is actually different for each apparatus, it is preferably determined whether free capacity in creating a list is sufficient with respect to the free capacity for the work memory.

Next, a flow of the display method according to the present embodiment will be described with reference to FIG. 6.

For example, when the user operates a scroll key (not shown) to scroll down (step B1), it is checked whether the list form is the first list or the second list (step B2). Here, when the list form is the first list, all the lists have been already read and it is not necessary to newly access the database 10, and the display range is shifted downward (step B3). In step B2, when the list form is the second list, a list element which the application 50 needs to scroll and display is requested to the database 10 and the required list element is read (step B4). Then, the added list element is added to the lowermost stage of the displayed list elements to display the new list element (step B5). At this time, the area for the work memory 20 saved for the list element, which does not require to be displayed, is released before newly adding a list element.

As described above, according to the embodiment of the present invention, the list form can be dynamically changed depending on the number of list elements such that the first list is employed when the number of list elements is small and the second list is employed when the number thereof is large. This function can be achieved only by adding a program (or module) for the added function without changing an existing application program.

Therefore, as compared with the fixed list form, the present embodiment can improve performance for displaying and restrict the amount of consumption of memory.

The present invention is not limited to the above embodiment and can accomplish various modifications without departing from the spirit thereof in implementation.

For example, although the first or second list is created depending on the number of list elements in the above embodiment, there may be employed the second list for a list whose list elements would dynamically change and increase in the future, such as address book or the number of received e-mail, even when the number of list elements is small.

According to the present invention, it is possible to provide a portable electronic device and a list display method having the advantages of the first and second methods without changing an existing application program.

Additional advantages and modifications will readily occur to those skilled in the art. Therefore, the invention in its broader aspects is not limited to the specific details, representative devices, and illustrated examples shown and described herein. Accordingly, various modifications may be made without departing from the spirit or scope of the general inventive concept as defined by the appended claims and their equivalents.

What is claimed is:

1. A portable electronic device comprising:
a database configured to store therein a plurality of lists each including at least one list element;
a display configured to display the list elements; and
a controller configured to read the list elements to be displayed from the database and to display the list elements on the display,
wherein the controller reads the list elements into a work memory for display from the database based on a identification data as to whether to read all the list elements into a work memory for display.

2. The portable electronic device according to claim 1, wherein the controller to read the all the list elements into the work memory, if the number of list element is smaller than a threshold decided in advance, free capacity for the work memory is sufficient, and access to the database is faster than a threshold decided in advance.

3. The portable electronic device according to claim 1, wherein the controller to read the list elements being capable of displaying, if the number of list element is bigger than the threshold decided in advance, or free capacity for the work memory is not sufficient, or access to the database is slower than the threshold decided in advance.

4. The portable electronic device according to claim 2, wherein the controller to read the list elements being capable of displaying, if the number of list element is bigger than the threshold decided in advance, or free capacity for the work memory is not sufficient, or access to the database is slower than the threshold decided in advance.
